(19) United States
(12) Patent Application Publication
(10) Pub. No.: US 2026/0243928 A1
(43) Pub. Date: Aug. 20, 2026

(54) POLARIZATION-BASED PLASMONIC SENSORS, SYSTEMS, AND METHODS

(71) Applicants: University of Southern California, Los Angeles, CA (US); California Institute of Technology, Pasadena, CA (US)

(72) Inventors: Chieh-Feng Chang, Pasadena, CA (US); Scott E. Fraser, Los Angeles, CA (US)

(73) Assignees: University of Southern California, Los Angeles, CA (US); California Institute of Technology, Pasadena, CA (US)

(21) Appl. No.: 19/161,035

(22) PCT Filed: Mar. 4, 2024
(86) PCT No.: PCT/US2024/018324

§ 371 Date: Aug. 29, 2025

Related U.S. Application Data
(60) Provisional application No. 63/488,171, filed on Mar. 2, 2023.

(51) Int. Cl. G02B 5/00; G01N 21/65; G02B 1/00

(52) U.S. Cl. CPC G02B 5/008; G01N 21/658; G02B 1/005

(57) ABSTRACT

Disclosed are plasmonic sensors, and systems and methods related to plasmonic sensors. The plasmonic sensors include 2024/182797 polarization-maintaining optical fibers to avoid cross-talk between wanted and unwanted components within a plasmonic response signal. The plasmonic sensors, systems, and methods can involve detecting components within a signal outside of the polarization direction of an excitation signal for reducing issues found in the signal matching the polarization direction of the excitation signal. The plasmonic sensors, systems, and methods use specific lattice arrangements of plasmonic material nanostructures.

WO

### CROSS-REFERENCE TO RELATED APPLICATIONS

This application claims the benefit under 35 U.S.C. § 119(e) of U.S. Provisional Application No. 63/488,171, filed Mar. 2, 2023, the contents of which are incorporated herein by reference in their entirety.

### TECHNICAL FIELD

The technology described herein relates to plasmonic sensors.

### BACKGROUND

Raman scattering is an optical phenomenon resulting from the interaction of excitation light with a sample, which generates scattered light. Surface-enhanced Raman scattering (SERS) can be used to enhance Raman scattering. SERS uses the interaction between light and metal on the nanoscale for local optical field enhancement between generally curved metal surfaces about 50 nanometers (nm) or less apart.

Optical fiber-based sensors and systems exist for SERS. However, issues exist with these conventional optical fiber-based sensors and systems. For example, conventional optical fiber-based sensors and systems suffer from a limited fiber length based on the signal-to-noise ratio. This issue arises from unwanted Stokes waves generated by the fiber itself, including back reflections of fiber-generated Stokes waves that can travel along the fiber to the detector and worsen the signal-to-noise ratio. Workarounds for these issues have been attempted. Such workarounds include, for example, using separate excitation and collection fibers; specialized fibers (e.g., photonic crystals or sapphire fiber); pulsed excitation; and higher-wavenumber detection. However, these workarounds have their own issues.

Thus, the present application discloses sensors, systems, and methods that are a solution to these and other issues with respect to conventional optical fiber-based sensors and systems.

### SUMMARY

An implementation of the present disclosure includes a plasmonic sensor. The plasmonic sensor includes a polarization-maintaining optical fiber having a proximal end and a distal end. The plasmonic sensor further includes plasmonic material nanostructures coupled to the distal end of the polarization-maintaining optical fiber.

A further aspect of the implementation includes the polarization-maintaining optical fiber having a length of at least about two meters.

A further aspect of the implementation includes the polarization-maintaining optical fiber having an effectiveness for detecting surface enhanced Raman scattering at least about 12.5 times greater than a plasmonic sensor with a non-polarization-maintaining optical fiber.

A further aspect of the implementation includes the plasmonic sensor including a plurality of pillars. Each pillar of the plurality of pillars can support one nanostructure of the plasmonic material nanostructures. The plasmonic sensor can further include a substrate coupled to the plurality of pillars. The substrate can couple the plurality of pillars and the plasmonic material nanostructures to the distal end of the polarization-maintaining optical fiber. The plasmonic sensor can also include a support structure coupling the substrate to the distal end of the polarization-maintaining optical fiber to form a gap between the substrate and the distal end of the polarization-maintaining optical fiber. In such an implementation, the plasmonic material nanostructures can be positioned within the gap between the substrate and the distal end of the polarization-maintaining optical fiber.

A further aspect of the implementation includes the plasmonic material nanostructures being arranged in a square lattice arrangement in a series of rows and a series of columns.

A further aspect of the implementation includes the plasmonic material nanostructures being arranged in a hexagonal lattice arrangement.

A further aspect of the implementation includes the plasmonic material nanostructures being arranged in a honeycomb lattice arrangement.

A further aspect of the implementation includes the plasmonic sensor including one or more of a polarizer, a Faraday rotator, or a half-wave plate coupled between the plasmonic material nanostructures and the distal end of the polarization-maintaining optical fiber. A gap can exist between one or more of the distal end of the polarization-maintaining optical fiber and the one or more of the polarizer, the Faraday rotator, or the half-wave plate.

An implementation of the present disclosure includes a system. The system includes a laser configured to provide an excitation signal having a first polarization direction. The system further includes a plasmonic sensor configured to generate a response signal responsive to the excitation signal. The response signal has the first polarization direction and a second polarization direction, different from the first polarization direction. The system also includes a spectrometer configured to measure the response signal with respect to the second polarization direction distinct from the first polarization direction.

A further aspect of the implementation includes the plasmonic sensor including plasmonic material nanostructures arranged in a series of rows parallel to an x-axis, the x-axis being perpendicular to a propagation direction of the excitation signal within the plasmonic sensor; a series of columns parallel to a y-axis, the y-axis being perpendicular to the propagation direction of the excitation signal within the plasmonic sensor; and the first polarization direction of the excitation signal being within a plane oriented at a 45 degree angle relative to the x-axis and the y-axis.

A further aspect of the implementation includes the second polarization direction being perpendicular to the first polarization direction.

A further aspect of the implementation includes the plasmonic sensor including a polarization-maintaining optical fiber. The system can include a channel for connecting the laser to the plasmonic sensor and the plasmonic sensor to the spectrometer. The channel can be polarization-maintaining with anisotropic Raman gains. The polarization-maintaining channel can be a polarization-maintaining fiber or polarization-maintaining photonic crystal fibers.

An implementation of the present disclosure includes a method. The method includes the step of providing an excitation signal to a plasmonic sensor. The excitation signal has a first polarization direction. The method further includes the step of receiving a response signal from the plasmonic sensor. The response signal has the first polarization direction and a second polarization direction, different form the first polarization direction. The method further includes the step of measuring the response signal for an optical property based only on the second polarization direction.

A further aspect of the implementation includes the second polarization direction being perpendicular to the first polarization direction.

A further aspect of the implementation includes the plasmonic sensor including plasmonic material nanostructures arranged within in a series of rows parallel to an x-axis, the x-axis being perpendicular to a propagation direction of the excitation signal; a series of columns parallel to a y-axis, the y-axis being perpendicular to the propagation direction of the excitation signal; and the first polarization of the excitation signal being arranged within a plane arranged at a 45 degree angle relative to the x-axis and the y-axis.

A further aspect of the implementation includes the excitation signal being generated by a laser and provided to the plasmonic sensor from the laser by a polarization-maintaining optical fiber. The response signal is received from the plasmonic sensor at a spectrometer from a polarization-maintaining optical fiber.

A further aspect of the implementation includes the method further includes the steps of measuring the response signal relative to the first polarization direction, and determining a ratio of the response signal based on the measured first polarization direction and the measured second polarization direction.

A further aspect of the implementation includes the optical property is based on Raman scattering or fluorescence.

The term embodiment and like terms, e.g., implementation, configuration, aspect, example, and option, are intended to refer broadly to all the subject matter of this disclosure and the claims below. Statements containing these terms should be understood not to limit the subject matter described herein or to limit the meaning or scope of the claims below. Implementations of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative implementations and modes for carrying out the present invention, when taken in connection with the accompanying drawings and the appended claims. Additional aspects of the disclosure will be apparent to those of ordinary skill in the art in view of the detailed description of various implementations, which is made with reference to the drawings, a brief description of which is provided below.

### BRIEF DESCRIPTION OF THE DRAWINGS

The drawings described herein constitute part of this specification and include exemplary implementations of the present invention which may be embodied in various forms. It is to be understood that in some instances, various aspects of the technology described herein may be shown exaggerated or enlarged to facilitate an understanding of the technology described herein. The drawings may not be to scale.

FIG. 1 shows a perspective view of a plasmonic sensor, according to aspects of the present disclosure.

FIG. 2 shows a side view of a plasmonic material nanostructure assembly, according to aspects of the present disclosure.

FIG. 3 shows a cross-sectional side view of a distal end of a plasmonic sensor, according to aspects of the present disclosure.

FIG. 4 shows a cross-sectional side view of a distal end of another plasmonic sensor, according to aspects of the present disclosure.

FIG. 5 shows a schematic view of a lattice arrangement of plasmonic material nanostructures, according to aspects of the present disclosure.

FIG. 6 shows a schematic view of an alternative lattice arrangement of plasmonic material nanostructures, according to aspects of the present disclosure.

FIG. 7 shows a schematic view of a lattice arrangement of plasmonic material nanostructures relative to a polarized excitation signal, according to aspects of the present disclosure.

FIG. 8 shows a schematic view of an alternative lattice arrangement of plasmonic material nanostructures relative to a polarized excitation signal, according to aspects of the present disclosure.

FIG. 9 is a plot showing normalized Raman signal strength for a square lattice arrangement of plasmonic material nanostructures with respect to different polarization angles of the excitation signal, according to aspects of the present disclosure.

FIG. 10 is a plot showing normalized Raman signal strength for the square lattice arrangement of plasmonic material nanostructures in FIG. 9 with respect to different polarization angles of the excitation signal for an illumination direction, according to aspects of the present disclosure.

FIG. 11 is a plot showing normalized Raman signal strength for another lattice arrangement of plasmonic material nanostructures with respect to different polarization angles of the excitation signal, according to aspects of the present disclosure.

FIG. 12 is a plot showing normalized Raman signal strength for the lattice arrangement of plasmonic material nanostructures in FIG. 11 with respect to different polarization angles of the excitation signal for an illumination direction, according to aspects of the present disclosure.

FIG. 13 is a plot showing reflection of an excitation signal off a lattice arrangement of plasmonic material nanostructures across different polarization angles of the excitation signal, according to aspects of the present disclosure.

FIG. 14 is a plot showing reflection of an excitation signal off another lattice arrangement of plasmonic material nanostructures across different polarization angles of the excitation signal, according to aspects of the present disclosure.

FIG. 15 is a plot showing reflection of an excitation signal off the lattice arrangement of plasmonic material nanostructures in FIG. 13 for different polarization angles of the excitation signal for an illumination direction, according to aspects of the present disclosure.

FIG. 16 is a plot showing reflection of an excitation signal off the lattice arrangement of plasmonic material nanostructures in FIG. 14 for different polarization angles of the excitation signal for an illumination direction, according to aspects of the present disclosure.

FIG. 17 shows a schematic view of an alternative lattice arrangement of plasmonic material nanostructures within a plasmonic sensor, according to aspects of the present disclosure.

FIG. 18 shows a perspective view of an alternative plasmonic sensor, according to aspects of the present disclosure.

FIG. 19 shows a sensor system, according to aspects of the present disclosure.

FIG. 20 shows another sensor system, according to aspects of the present disclosure.

### DETAILED DESCRIPTION

Various implementations are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various implementations disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

Inventive aspects of the present disclosure involve intrinsic Raman signals within polarization-maintaining optical fibers generally having the same polarization as an excitation laser and generally retaining the same polarization when back-reflected from plasmonic material nanostructures. Further, inventive aspects of the present disclosure involve Raman signals generated from plasmonic material nanostructures coupling into a polarization direction perpendicular to the polarization direction of the excitation signal within plasmonic sensors.

According to some aspects, the present disclosure is directed to plasmonic sensors, systems, and methods that measure response signals from plasmonic material nanostructures within a polarization direction that is outside of the polarization direction of the excitation signal. Measuring the polarization direction that is outside of the polarization direction of the excitation signal avoids noise that is inherently present in the polarization direction of the excitation signal. Yet, if desired, the polarization direction within the response signal that matches the polarization direction of the excitation signal can also be measured, such as for situations where the total strength of particular aspects of the response signal is desired (e.g., total strength of a Raman signal) or where a ratio between two polarization directions is desired (e.g., polarization direction of the excitation and polarization direction outside of the excitation signal).

According to some aspects, the present disclosure also is directed to plasmonic sensors that include a polarization-maintaining optical fiber. The polarization-maintaining optical fiber supports at least two directions of polarization. A response signal generated in response to an excitation signal at the plasmonic sensor can be measured outside of the polarization direction of the excitation signal. As discussed above, this avoids noise that is present in the response signal with the same polarization direction as the excitation signal. Further, the polarization-maintaining optical fiber of the plasmonic sensor reduces the cross talk that occurs within a non-polarization-maintaining optical fiber, which further reduces the noise within the polarization direction of the response signal that is outside of the polarization direction of the excitation signal.

According to some aspects, the present disclosure also is directed to plasmonic sensors, systems, and methods that include an arrangement of the plasmonic material nanostructures that provides for the largest signal-to-noise ratio within the response system. The plasmonic material nanostructures can be arranged within the plasmonic sensors and systems according to a square lattice arrangement. Further, the square lattice arrangement can be positioned relative to the polarization direction of the excitation signal such that the angle between the rows of the square lattice arrangement and the polarization direction of the excitation signal is 45 degrees. Despite this being generally being disclosed as an incorrect arrangement, the arrangement provides the strongest signal in the direction perpendicular to the polarization direction of the excitation signal, which results in the best signal-to-noise ratio.

According to some aspects, the present disclosure also is directed to plasmonic sensors, systems, and methods that include an arrangement of the plasmonic material nanostructures which allows for any polarization direction of the excitation signal illuminating the plasmonic material nanostructures without impacting a total Raman signal strength.

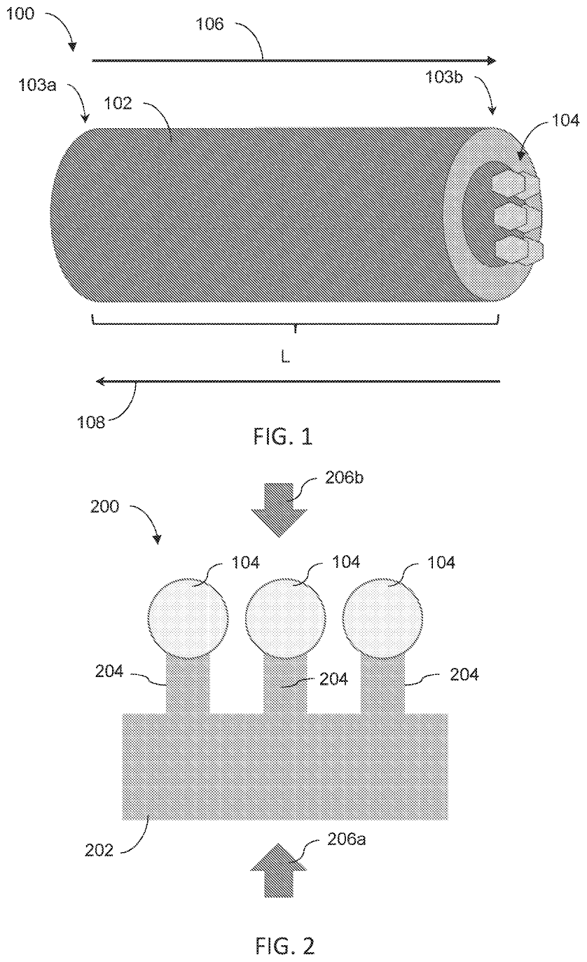

FIG. 1 shows a perspective view of a plasmonic sensor 100, according to aspects of the present disclosure. The plasmonic sensor 100 includes a polarization-maintaining optical fiber 102. The polarization-maintaining optical fiber 102 has a proximal end 103a and a distal end 103b. The polarization-maintaining optical fiber 102 aids in maintaining at least two different directions of polarization. For example, the polarization-maintaining optical fiber 102 helps reduce crosstalk in a response signal that passes through the polarization-maintaining optical fiber 102. Less crosstalk increases the signal-to-noise ratio between two different directions of polarization. Thus, a polarized signal that passes through the polarization-maintaining optical fiber 102 better maintains its polarization direction along the length L of the polarization-maintaining optical fiber 102 than non-polarization-maintaining optical fibers. As a result/benefit, a polarization direction of a response signal that passes through the polarization-maintaining optical fiber 102 better maintains its polarization direction and interacts less with other polarization directions within the response signal, as further discussed below.

Coupled to the distal end 103b of the polarization-maintaining optical fiber 102 are plasmonic material nanostructures 104. The plasmonic material nanostructures 104 can be any type of plasmonic material nanostructures, such as the metal being gold, silver, aluminum, or another plasmonic material, or a combination of metals with the outermost layer being a plasmonic material. To the extent not disclosed herein, the plasmonic material nanostructures 104 also can be those described in U.S. Pat. No. 9,512,000B2; U.S. Pat. No. 9,913,603B2; U.S. Pat. No. 9,993,185B2; and U.S. Pat. No. 11,002,908B2, the contents of which is hereby incorporated by reference herein in their entirety.

The plasmonic material nanostructures 104 can also be formed according to various known ways of forming plasmonic material nanostructures, as described in U.S. Pat. Nos. 9,512,000B2; 9,913,603B2; 9,993,185B2; and 11,002,908B2. For example, the plasmonic material nanostructures 104 (as well as all plasmonic material nanostructures disclosed herein) can be nano-bulb or hemispherical nanostructures; core-shell or shell-layer(s) nanostructures (including nanocups); or cylindrical, elliptically-cylindrical, ellipsoid-like, cubic, or rectangular nanostructures. Further, the plasmonic material nanostructures 104 can be formed by a thermal treatment of, for example, gold on surfaces or nanostructures. The plasmonic material nanostructures 104 can be formed by deposition of metal on fabricated nanostructures, self-assembled monolayer of nano-beads, wrinkled surfaces with nanoscopic patterns, etc. The plasmonic material nanostructures 104 can be an arrangement of synthesized metal nano-crystals, local growth of metal nanostructures, etc., or modification of metal nanostructures via focused ion beam, ion milling, etc.

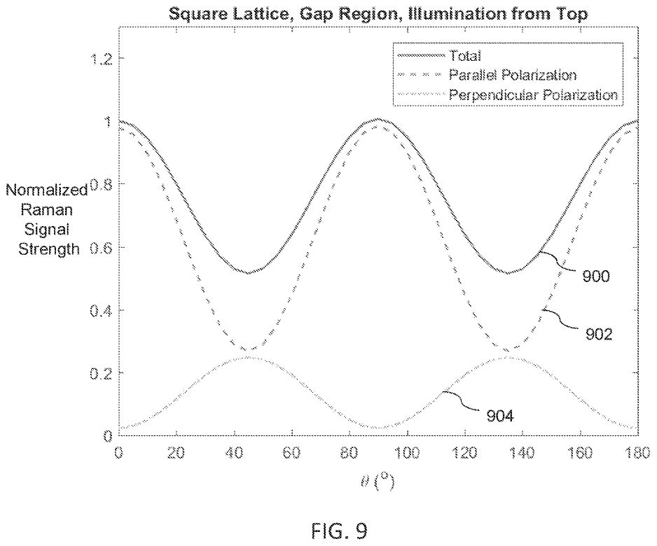

Line 106 in FIG. 1 represents an excitation signal traveling along the polarization-maintaining optical fiber 102. Line 108 represents a response signal resulting from the excitation signal 106 interacting with the plasmonic material nanostructures 104. The response signal 108 includes two components of Stokes waves, which can be detected at the proximal end 103a. These two components are the intrinsic Raman signals generated in the polarization-maintaining optical fiber 10, I_{f}, and the SERS signals from plasmonic material nanostructures 104, Iₛ. The effective length L_{eff} of the polarization-maintaining optical fiber 102 can be defined as when I_{f}~=Iₛ; namely, the effective length L_{eff} defines the maximal fiber length when the signal-to-noise ratio drops to ~1. When using the polarization-maintaining optical fiber 102 of the present plasmonic sensor 100, the effective length L_{eff} becomes=R₁*R₂, where R₁ is the ratio of nanostructure Raman signals in the perpendicular direction, I_{perpedicular}/Iₛ, and R₂ is the reduction ratio of intrinsic fiber Raman signals in the perpendicular direction, I_{f}/I_{f, perpendicular}. As generally further discussed below relative to FIGS. 9-16 for exemplary specific examples, examples of R₁ and R₂ can be 0.25 and 50, respectively, which results in an increase of effectiveness of at least about 12.5× over conventional plasmonic sensors based on non-polarization-maintaining optical fiber and allows for the polarization-maintaining optical fiber 102 of the plasmonic sensor 100 to be at least about 2 meters long. Thus, the length of the polarization-maintaining optical fiber 102 of the plasmonic sensor 100 can be at least about 12.5 times longer than the length of a plasmonic sensor that does not include the polarization-maintaining optical fiber 102. This effectiveness can further increase as the effectiveness of optical fibers in general increases. This effectiveness may further increase depending on the Raman-activity of the material being analyzed.

Referring to FIG. 2, shown is a side view of a plasmonic material nanostructure assembly 200, according to aspects of the present disclosure. The plasmonic material nanostructure assembly 200 can be what is coupled to the distal end 103b of the polarization-maintaining optical fiber 102 to provide the plasmonic material nanostructures 104 within the plasmonic sensor 100.

The plasmonic material nanostructure assembly 200 includes the plasmonic material nanostructures 104. As disclosed above, the plasmonic material nanostructures 104 can be any plasmonic material nanostructure used for the purpose of SERS, such as those disclosed in U.S. Pat. Nos. 9,512,000B2; 9,913,603B2; 9,993,185B2; and 11,002,908B2. For example, the plasmonic material nanostructures 104 can be gold nanobulbs having a diameter of about 200 nm to about 300 nm with a spacing of about 50 nm or less.

In addition, the plasmonic material nanostructure assembly 200 includes a substrate 202. The substrate 202 can be any type of substrate used for the purpose of forming and/or supporting plasmonic material nanostructures, such as those disclosed in U.S. Pat. Nos. 9,512,000B2; 9,913,603B2; 9,993,185B2; and U.S. Pat. No. 11,002,908B2. According to some aspects, the substrate 202 can be formed of silicon, silicon dioxide, or another material that is compatible with the nanostructure fabrication process.

Connecting the plasmonic material nanostructures 104 to the substrate 202 are nanopillars 203. The nanopillars 203 can be any type of nanopillars used for the purpose of forming and/or supporting plasmonic material nanostructures, such as those disclosed in U.S. Pat. Nos. 9,512,000B2; 9,913,603B2; 9,993,185B2; and 11,002,908B2. For example, the pillars 203 (as well as all pillars disclosed herein) can be cylindrical, elliptical, cubic, or rectangular nano-pillars. The pillars 203 can be made of silicon, silicon dioxide, or another material that can be fabricated with good resolution on the nanometer scale.

Further, according to some implementations, the pillars 203 can be removed. Instead, the plasmonic material nanostructures 104 can be attached directly to the substrate 202. In such implementations, an optional thin film (or films) can be between plasmonic material nanostructures 104 and the substrate 202. Alternatively, in some implementations, the substrate 202 and the pillars 203 can be removed. Instead, the plasmonic material nanostructures 104 can be attached directly to the distal end 103b of the polarization-maintaining optical fiber 102 (FIG. 1).

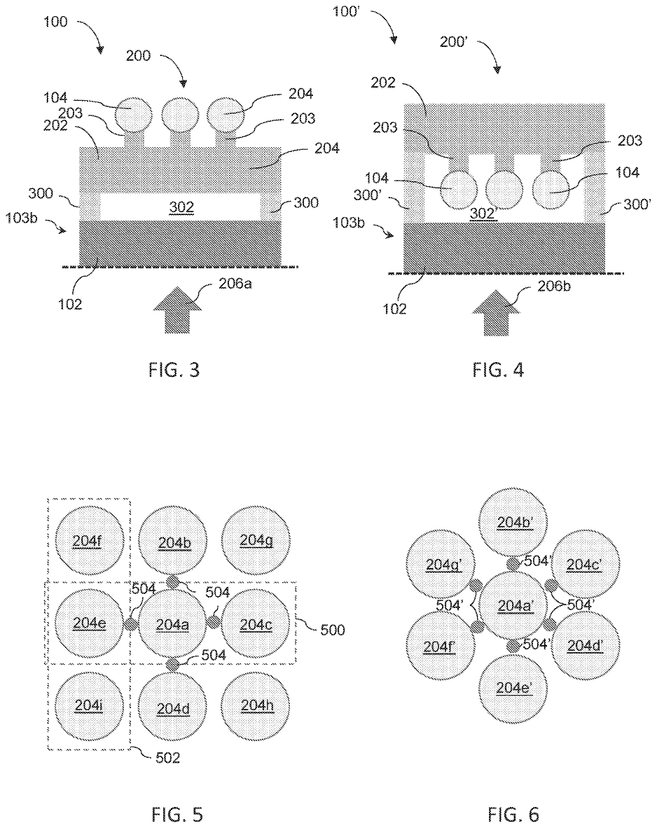

As disclosed further with respect to FIGS. 3 and 4, the plasmonic material nanostructure assembly 200 can be arranged on the distal end 103b of the polarization-maintaining optical fiber 102 such that an excitation signal passes through the plasmonic material nanostructure assembly 200 in the direction of arrow 206a or arrow 206b. Specifically, and referring to FIG. 3, shown is a cross-sectional side view of the distal end 103b of the plasmonic sensor 100 of FIG. 1, according to aspects of the present disclosure. The plasmonic material nanostructure assembly 200 is positioned on the distal end 103b of the polarization-maintaining optical fiber 102 so that an excitation signal (represented by arrow 206a) passes first through the substrate 204. This is considered to be a substrate illumination configuration. Alternatively, and as shown in FIG. 4, which shows a cross-sectional side view of the distal end 103b′ of another plasmonic sensor 100′, according to aspects of the present disclosure, an excitation signal (represented by arrow 206b) passes first around the plasmonic material nanostructures 104 before passing through the substrate 202 of the plasmonic material nanostructure assembly 200′. This is considered to be a top illumination configuration.

As shown in FIGS. 3 and 4, the plasmonic material nanostructure assemblies 200 and 200′ can be coupled to the distal end 103b of the polarization-maintaining optical fiber 102 via support structures 300 and 300′, respectively. The support structures 300 and 300′ can provide gaps 302 and 302′ between the plasmonic material nanostructure assemblies 200 and 200′, respectively. In the case of the plasmonic material nanostructure assembly 200, the gap 302 can be empty or filled with, for example, a gas. However, according to some implementations, the plasmonic material nanostructure assembly 200 can be coupled directly to the distal end 103b of the polarization-maintaining optical fiber 102 without the support structures 300 and the gap 302. In the case of the plasmonic material nanostructure assembly 200′, the gap 302′ provides room for the plasmonic material nanostructures 104. The remainder of the gap 302′ can be empty of filled with, for example, a gas.

Referring to FIG. 5, shown is a schematic view of a lattice arrangement of plasmonic material nanostructures 204a-204i (collectively referred to as plasmonic material nanostructures 204), according to aspects of the present disclosure. The same disclosure for the plasmonic material nanostructures 104 provided above applies to the plasmonic material nanostructures 204. The plasmonic material nanostructures 204 are arranged in a square lattice arrangement. More specifically, the plasmonic material nanostructures 204 are arranged in a series of rows 500, such as three rows 500 as shown. The plasmonic material nanostructures 204 further are arranged in a series of columns 502, such as three columns 502 as shown. The result is the center plasmonic material nanostructure 204a being surrounded by four closest plasmonic material nanostructures 204b-204e. Between the plasmonic material nanostructure 204a and each of the plasmonic material nanostructures 204b-204e are hot spots 504, resulting in four hot spots 504. These hot spots 504 promote SERS.

Referring to FIG. 6, shown is a schematic view of an alternative lattice arrangement of plasmonic material nanostructures 204a′-204g′ (collectively referred to as plasmonic material nanostructures 204′), according to aspects of the present disclosure. The plasmonic material nanostructures 204′ are arranged in a hexagonal arrangement. More specifically, the plasmonic material nanostructures 204′ are arranged with a center plasmonic material nanostructure 204a′ surrounded by equally spaced apart plasmonic material nanostructures 204b′-204g′, which are also all equally spaced from the center plasmonic material nanostructure 204a′. Between the plasmonic material nanostructure 204a′ and each of the other plasmonic material nanostructures 204b′-204g′ are hot spots 504, resulting in six hot spots 504. As disclosed above, these hot spots 504 promote SERS.

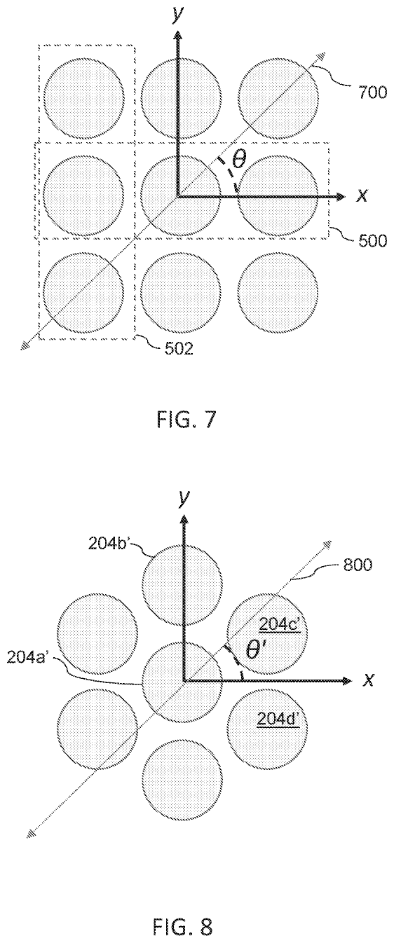

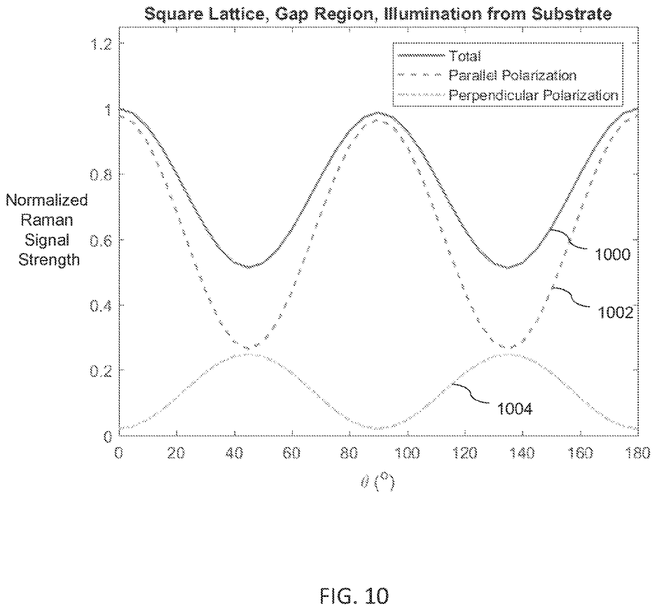

Referring to FIG. 7, shown is a schematic view of the plasmonic material nanostructures 204 of FIG. 5 relative to an excitation signal 700, according to aspects of the present disclosure. A discussed above, a coordinate system was applied to the plasmonic material nanostructures 204 to investigate the best orientation of the polarization direction of the excitation signal 700 applied to the plasmonic material nanostructures 204. Specifically, the x-axis was set to be parallel to the rows 500, and the y-axis was set to be parallel to the columns 502. Within this coordinate system, the polarization of the excitation signal 700 is provided in a direction relative to the plasmonic material nanostructures 204 at an angle θ relative to the x-axis. The angle θ can vary between 0 to 180 degrees. The results of the analysis of the effects of the angle θ of the excitation signal 700 are shown and disclosed with respect to FIGS. 9 and 10.

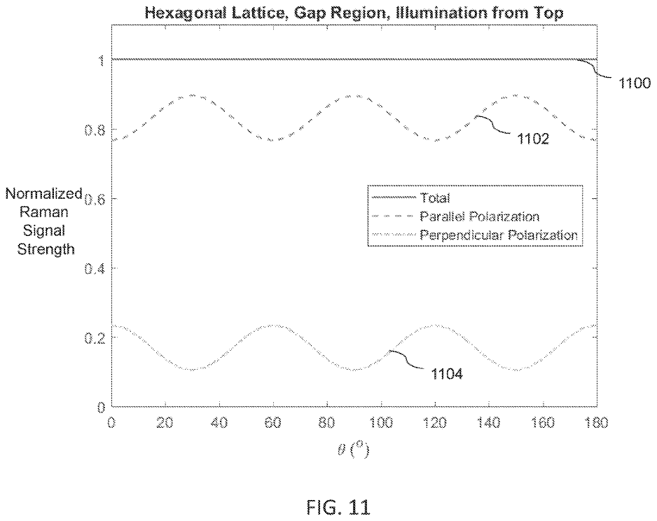

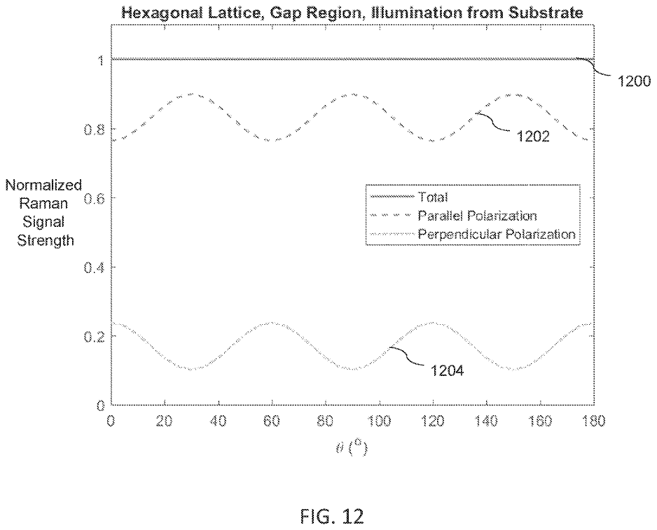

Referring to FIG. 8, shown is a schematic view of the alternative lattice arrangement of plasmonic material nanostructures 204′ of FIG. 6 relative to an excitation signal 800, according to aspects of the present disclosure. A coordinate system was applied to the plasmonic material nanostructures 204′ to investigate the best orientation of the polarization direction of the excitation signal 800 applied to the plasmonic material nanostructures 204′. Specifically, the x-axis was set to pass through the center of the plasmonic material nanostructure 204a′ and be spaced equally between the adjacent plasmonic material nanostructures 204c′ and 204d′. The y-axis was set to pass through the center of the plasmonic material nanostructures 204a′ and 204b′. Within this coordinate system, the polarization of the excitation signal 800 can be provided in a direction relative to the plasmonic material nanostructures 204 at an angle θ′ relative to the x-axis. The angle θ′ can vary between 0 to 180 degrees. The results of the analysis of the effects of the angle θ′ of the excitation signal 800 are shown and disclosed with respect to FIGS. 11 and 12.

For the purpose of analyzing various lattice arrangements for plasmonic material nanostructures relative to various polarization directions of the excitation signal, tests were conducted on the lattice arrangements of FIGS. 7 and 8. Intensity measurements for Stokes signals with a polarization parallel with the polarization direction of the excitation signal were measured. Intensity measurements for Stokes signals with a polarization perpendicular with the polarization direction of the excitation signal also were measured. These are shown and disclosed with respect to FIGS. 9-12 below.

Referring to FIG. 9, shown is a plot of normalized Raman signal strength for the lattice arrangement of plasmonic material nanostructures in FIGS. 5 and 7 with respect to the polarization direction of the excitation signal at different angles θ (FIG. 7), according to aspects of the present disclosure. Illumination of the plasmonic material nanostructures 204 was the top illumination, as shown in FIG. 4. Measurement of the Raman signal strength occurred at a hot spot 504 (FIG. 5). The plot in FIG. 9 specifically shows the total normalized Raman signal strength for different angles θ, as represented by line 900. The plot in FIG. 9 also shows the normalized Raman signal strength measured along a polarization direction parallel to the polarization direction of the excitation signal 700 (FIG. 7) for different angles θ, as represented by line 902. The plot in FIG. 9 also shows the normalized Raman signal strength along a polarization direction perpendicular to the polarization direction of the excitation signal 700 (FIG. 7) for different angles θ, as represented by line 904. As shown in FIG. 9, it was found that the largest strength in the normalized Raman signal along a polarization direction perpendicular to the polarization direction of the excitation signal 700 occurred at an angle θ of 45 and 135 degrees. It also was found that the smallest strength in the normalized total Raman signal, and the normalized Raman signal along a polarization direction parallel to the polarization direction of the excitation signal 700, occurred at an angle of θ of 45 and 135 degrees. Although the strength of the Raman signal (i.e., line 900) is lowest at an angle θ of 45 and 135 degrees, the angle θ of 45 or 135 degrees for the polarization direction of the excitation signal 700 relative to the rows 500 and columns 502 provides the best results. Indeed, conventionally, using an excitation signal that is arranged relative to a square lattice arrangement at an angle θ of 45 degrees was avoided because, as shown, this configuration results in the lowest total Raman signal strength. However, it was found that the angle θ of 45 or 135 degrees for the current configuration is actually preferred when separating the response signal into parallel and perpendicular components because of the greater separation.

FIG. 10 is a plot showing normalized Raman signal strength for the lattice arrangement of plasmonic material nanostructures 204 in FIGS. 5 and 7 with respect to the polarization direction of the excitation signal at different angles θ (FIG. 7), according to aspects of the present disclosure. The results shown in FIG. 10 are for illumination of the plasmonic material nanostructures 204 from the substrate, as shown in FIG. 3. Measurement of the Raman signal strength occurred at a hot spot 504 (FIG. 5). The results are similar to what is shown in FIG. 9, with lines 1000, 1002, and 1004 corresponding to the same conditions as lines 900, 902, and 904 disclosed above for FIG. 9, respectively. Thus, illumination from the top (FIGS. 4 and 9) and illumination from the substrate (FIGS. 3 and 10) provide the same results with respect to the best angle θ (FIG. 7) to use for illuminating the plasmonic material nanostructures 204 with respect to a square lattice arrangement of the plasmonic material nanostructures 204.

The plots of FIGS. 9 and 10 show that the plasmonic material nanostructures 204 having a square lattice arrangement and the polarization direction of the excitation signal being oriented 45 degrees relative to the square lattice arrangement, as disclosed with respect to FIG. 7, provides the best arrangement for increasing the length of the polarization-maintaining optical fiber 102. This is because the square lattice arrangement and the 45 degree angle was found to provide the largest portion of the response signal in a polarization direction perpendicular to the excitation direction of the excitation signal, and this portion is least affected by noise within the fiber of the plasmonic sensor. Thus, despite the total strength of the Raman signal being the lowest when the polarization direction of the excitation signal is oriented 45 degrees relative to the square lattice arrangement, this is the best orientation to use for the square lattice arrangement.

Referring to FIG. 11, shown is a plot of normalized Raman signal strength for the lattice arrangement of plasmonic material nanostructures in FIGS. 6 and 8 with respect to the polarization direction of the excitation signal at different angles θ′ (FIG. 8), according to aspects of the present disclosure. Illumination of the plasmonic material nanostructures 204′ was from the top, as shown in FIG. 4. Measurement of the Raman signal strength occurred at a hot spot 504′ (FIG. 6). As shown in FIG. 11, it was found that, within a response signal generated from the excitation signal 800 (FIG. 8), the strength of the Raman signal remains constant over the range of the angle θ between 0 to 180 degrees. Specifically, this can be seen in the plot of FIG. 11, which shows the normalized Raman signal strength within a response signal, responsive to the excitation signal 800, across various angles θ′. The total strength of the Raman signal (i.e., line 1100) remains constant across the angle θ of 0 and 180. The strength of the Raman signal in a direction perpendicular to the excitation signal 800 (i.e., line 1104) is the highest at an angle θ′ of 0, 60, 120, and 180 degrees. The strength of the Raman signal in a direction parallel to the excitation signal 800 (i.e., line 1102) is the lowest at an angle θ′ of 0, 60, 120, and 180 degrees. Thus, the angle θ′ of 0, 60, 120, and 180 degrees for the polarization of the excitation signal 800 relative to the x-axis provides the best results by maximizing the strength of the Raman signal perpendicular to the polarization direction of the excitation signal. However, the results for the hexagonal lattice structure are not as good (e.g., intense) as the results for the square lattice arrangement disclosed with respect to FIGS. 9 and 10.

FIG. 12 is a plot showing normalized Raman signal strength for the lattice arrangement of plasmonic material nanostructures 204′ in FIGS. 6 and 8 with respect to the polarization direction of the excitation signal at different angles θ′ (FIG. 8), according to aspects of the present disclosure. However, the results shown in FIG. 12 are for illumination of the plasmonic material nanostructures 204′ from the substrate, as shown in FIG. 3. Measurement of the Raman signal strength occurred at a hot spot 504′ (FIG. 6). The results are similar to what is shown in FIG. 11, with lines 1200, 1202, and 1204 corresponding to the same conditions as lines 1100, 1102, and 1104 disclosed above for FIG. 11, respectively. Thus, illumination from the top (FIGS. 4 and 11) and illumination from the substrate (FIGS. 3 and 12) provide the same results with respect to the best angle θ′ to use for illuminating the plasmonic material nanostructures 204′ in a hexagonal lattice arrangement.

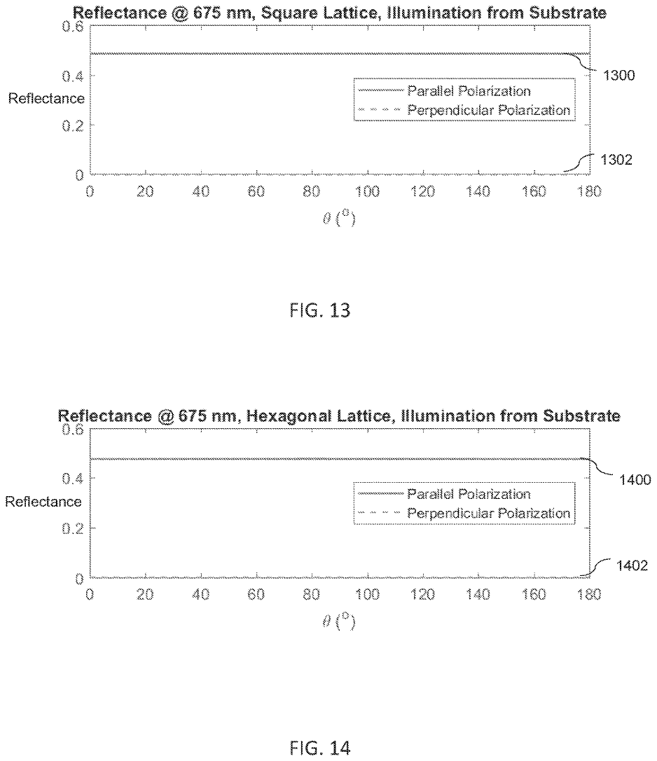

FIG. 13 is a plot showing the intensity of the reflection of an excitation signal off a lattice arrangement of plasmonic material nanostructures across a range of excitation directions, according to aspects of the present disclosure. The intensity was measured at a wavelength of 675 nm. Plasmonic material nanostructures were arranged in a square lattice arrangement, such as that shown in FIGS. 5 and 7. The direction of the polarization of the excitation signal was also characterized relative to the square lattice arrangement according to the coordinate system and angle θ as shown in FIG. 7. As can be seen from the plot in FIG. 13, reflection of the excitation signal off the square lattice arrangement of plasmonic material nanostructures remained within the polarization direction of the excitation signal. Specifically, line 1300 in FIG. 13 represents the strength of the reflectance of the excitation signal within the polarization direction of the excitation signal received in a plasmonic sensor after illuminating the plasmonic material nanostructures with an excitation signal across the angle θ (FIG. 7) between 0 and 180 degrees. Line 1302 in FIG. 13 represents the strength of the reflectance of the excitation signal within the perpendicular direction to the excitation signal received in a plasmonic sensor after illuminating the plasmonic material nanostructures with the excitation signal at different angles θ (FIG. 7) between 0 and 180 degrees. Line 1300 remains constant around a reflectance value of about 0.5, and line 1302 remains constant around a reflectance value of about 0, for all angles θ between 0 and 180 degrees. Thus, generally no reflectance of the excitation signal off the plasmonic material nanostructures enters the plasmonic sensor at a perpendicular polarization direction relative to the polarization direction of the excitation signal, which further evidences the benefit of measuring the Raman signal strength outside of the polarization direction of the excitation signal.

The same analysis occurred for the hexagonal lattice arrangement. Specifically, FIG. 14 is a plot showing the intensity of the reflection of an excitation signal off a lattice arrangement of plasmonic material nanostructures across a range of excitation directions, according to aspects of the present disclosure. The plasmonic material nanostructures for FIG. 14 were arranged in a hexagonal lattice arrangement, such as that shown in FIGS. 6 and 8. The direction of the polarization of the excitation signal was also characterized relative to the hexagonal lattice arrangement according to the coordinate system and angle θ as shown in FIG. 8. As can be seen from the plot in FIG. 14, reflection of the excitation signal off the hexagonal lattice arrangement of plasmonic material nanostructures remained within the polarization direction of the excitation signal. Specifically, line 1400 in FIG. 14 represents the strength of the reflectance of the excitation signal within the polarization direction of the excitation signal received in a plasmonic sensor after illuminating the plasmonic material nanostructures with an excitation signal over the range of the angle θ′ (FIG. 8) between 0 and 180 degrees. Line 1402 in FIG. 14 represents the strength of the reflectance of the excitation signal within the perpendicular direction to the excitation signal received in a plasmonic sensor after illuminating the plasmonic material nanostructures with the excitation signal over the range of the angle θ′ (FIG. 8) between 0 and 180 degrees. Line 1400 remains constant around a reflectance value of about 0.5, and line 1402 remains constant around a reflectance value of about 0 for all angles θ′ between 0 and 180 degrees. Thus, generally no reflectance of the excitation signal off the plasmonic material nanostructures enters the plasmonic sensor at a perpendicular polarization direction relative to the polarization direction of the excitation signal. This indicates that analysis of the polarization direction within the response signal that is perpendicular to the polarization direction of the excitation signal will include less unwanted reflectance of the excitation signal off of the plasmonic material nanostructures for all angles of the excitation signal.

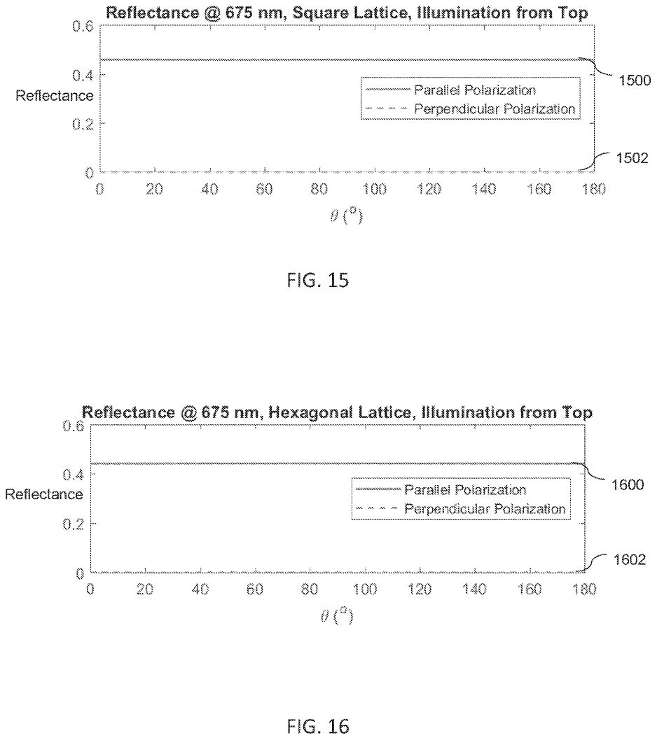

The excitation signal illuminated the respective plasmonic material nanostructures from the substrate, such as that shown in FIG. 3, to generate the information shown in FIGS. 13 and 14. Thus, the same analysis was performed for respective plasmonic material nanostructures but with respect to illumination in a top arrangement, such as that shown in FIG. 4. FIG. 15 is a plot showing reflection of an excitation signal off a lattice arrangement of plasmonic material nanostructures identical to the conditions for FIG. 13 but with respect to a top illumination direction, according to aspects of the present disclosure. FIG. 16 is a plot showing reflection of an excitation signal off a lattice arrangement of plasmonic material nanostructures identical to the conditions for FIG. 14 but with respect to a top illumination direction, according to aspects of the present disclosure. As can be seen from lines 1500 and 1600 in FIGS. 15 and 16, respectively, reflectance of the excitation signal across the range of angles θ and θ′, respectively, remains constant around about 0.45 within the polarization direction of the excitation signal. Further, as can be seen from lines 1502 and 1602 in FIGS. 15 and 16, respectively, reflectance of the excitation signal across the range of angles θ and θ′, respectively, remains constant around about 0 perpendicular to the polarization direction of the excitation signal. Thus, generally no reflectance of the excitation signal enters the polarization direction perpendicular to the polarization direction of the excitation signal for all angles θ and θ′ between 0 and 180 degrees. This indicates that analysis of the polarization direction within the response signal that is perpendicular to the polarization direction of the excitation signal will include less unwanted reflectance of the excitation signal off the plasmonic material nanostructures for all angles of the excitation signal.

FIGS. 11, 12, 14, and 16 show benefits of the hexagonal lattice arrangement of the plasmonic material nanostructures. Specifically, detection of the total Raman signal strength is independent of the polarization direction of the excitation signal. This can be used for special use cases/analysis when the total Raman signal strength is wanted. Thus, the hexagonal lattice arrangement allows for easier manufacturing because no strict alignment is required. It also allows for easier quantitative analysis because there is a self-referenced quantitative Raman measurement. Relative to the square lattice arrangement, there are two more hot spots (e.g., hot spots 504′ in FIG. 6 relative to hot spots 504 in FIG. 5). The greater number of hot spots can lower the detection floor of the plasmonic sensor.

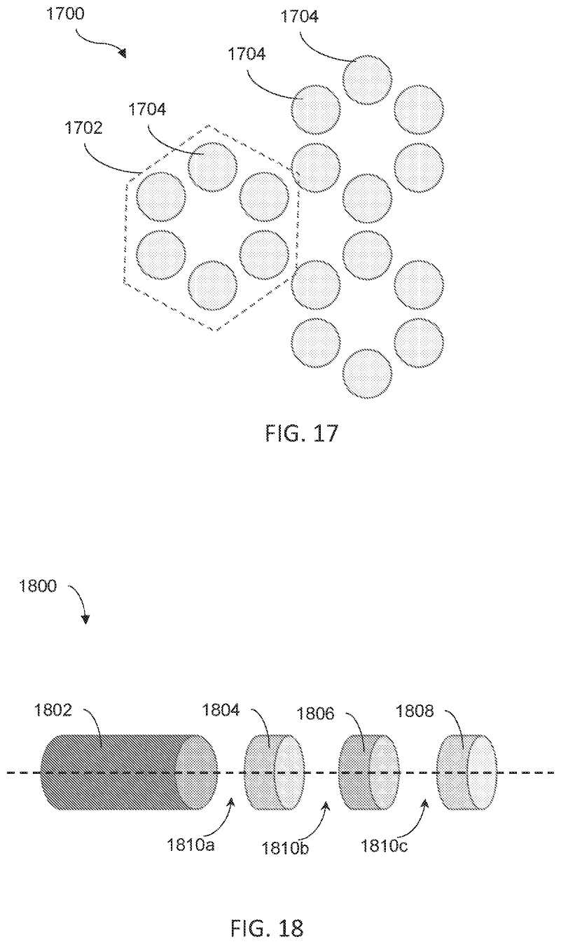

Although the plasmonic material nanostructures of the present disclosure have been disclosed primarily with respect to being in a square lattice arrangement or a hexagonal lattice arrangement, the number and arrangement of the plasmonic material nanostructures within a plasmonic sensor can vary. According to some implementations, there can be just two plasmonic material nanostructures. According to other implementations, there can be various other larger number of plasmonic material nanostructures arranged in any geometric arrangement, with adjacent pairs of plasmonic material nanostructures being generally around 50 nm or less apart. For example, there can be dimer, trimer, quadramer, honeycomb, etc. arrangements of plasmonic material nanostructures. FIG. 17 shows a schematic view of an alternative lattice arrangement 1700 of plasmonic material nanostructures 1704, according to aspects of the present disclosure. The plasmonic material nanostructures 1704 are disclosed the same as the plasmonic material nanostructures 104 disclosed above and can be arranged in an array of hexagonal ring arrangements 1702 with a reasonably small number of directions for roughly smallest gaps.

Referring back to the plasmonic sensor shown in FIG. 1, one or more additional components can be present, as shown and disclosed with respect to FIG. 18. These additional components can be added to further increase the effectiveness of the plasmonic sensor, which can increase fiber length. Specifically, FIG. 18 shows a perspective view of an alternative plasmonic sensor 1800, according to aspects of the present disclosure. In addition to the polarization-maintaining optical fiber 1802, which is as disclosed above with respect to the polarization-maintaining optical fiber 102, the plasmonic sensor 1800 can include a polarizer 1804, a Faraday rotator 1806, and/or a half-wave plate 1808.

The combination of the polarizer 1804 and the Faraday rotator 1806 functions like an isolator against the polarization of the excitation signal. The polarizer 1804 can be configured to allow a polarization y, which matches the polarization direction of the excitation signal. The Faraday rotator then rotates the polarization direction by 45 degrees. A resulting response signal is then rotated 45 degrees by the Faraday rotator, which further rotates the reflection of the excitation signal out of the polarization y and rotates the polarization of the desired components of the response signal into the polarization y, which further reduces unwanted noise and back-reflection to increase effectiveness. This arrangement allows for SERS signals polarized perpendicular to the excitation polarization to be detected instead of blocked. For the square lattice arrangement of FIG. 7, the columns of the square lattice can be aligned with the polarization y. For the hexagonal lattice arrangement of FIG. 8, the angle θ′ (FIG. 8) can be 105 degrees.

The combination of all three components, i.e., the polarizer 1804, the Faraday rotator 1806, and the half-wave plate 1808, constitutes a different implementation similar to an isolator against the polarization of the excitation signal. The polarizer 1804 can be configured to allow a polarization y, which matches the excitation direction polarization. The Faraday rotator 1806 then rotates the excitation signal polarization by 45 degrees. The half-wave plate 1808 then rotates the excitation signal polarization by another 45 degrees. Thus, when an excitation signal travels through the Faraday rotator 1806, gets back-reflected, and then travels through the Faraday rotator 1806 again, the total rotation will be 90 degrees. When the excitation signal travels through the half-wave plate 1808, gets back-reflected, and travels through the half-wave plate 1808 again, the total rotation will be θ degrees instead of 90 degrees. Namely, the effects would accumulate for the Faraday rotator 1806 and the effects would cancel each other out for a half-wave plate 108 because the Faraday rotator 1806 is a non-reciprocal component and the half-wave plate 1808 is a reciprocal component. The square lattice of the plasmonic material nanostructures can be rotated 45 degrees relative to what is shown in FIG. 7.

Not shown in FIG. 18 are the plasmonic material nanostructures. However, the plasmonic material nanostructures are coupled to a distal end (rightmost in the orientation of FIG. 18) of whichever component is the distal component (rightmost in the orientation of FIG. 18) within the plasmonic sensor 1800. The orientation and arrangement of the plasmonic material nanostructures within the plasmonic sensor 1800 can be any orientation and arrangement disclosed herein.

Optionally, the plasmonic sensor 1800 can include one or more gaps 1810a, 1810b, or 1810c (collectively referred to as gaps 1810). Cladding of the polarization-maintaining optical fiber 1802, or another support structure (e.g., pure glass), can be used to support the polarizer 1804, the Faraday rotator 1806, and/or the half-wave plate 1808 within the plasmonic sensor 1800 with the gaps 1810 therebetween.

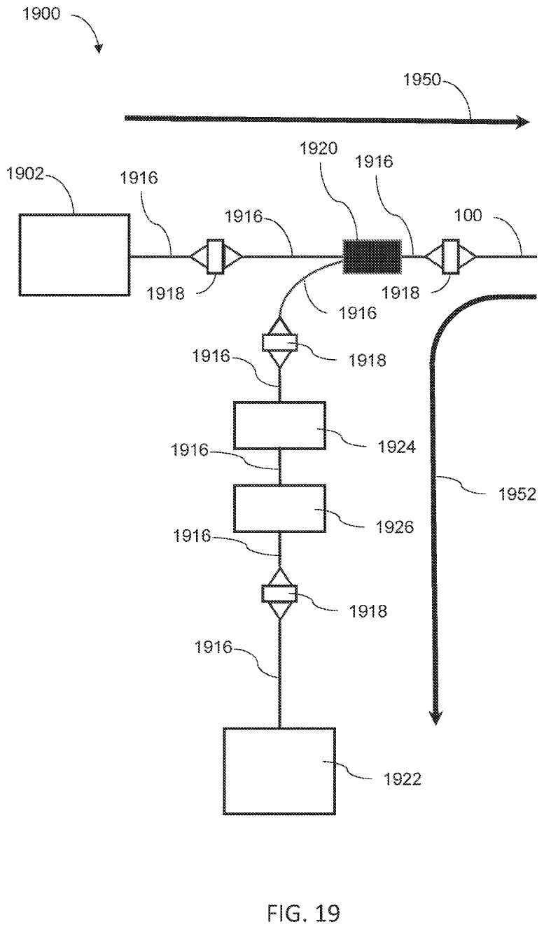

FIG. 19 shows a sensor system 1900, according to aspects of the present disclosure. The system 1900 includes a laser 1902 to generate a polarized excitation signal. The laser 1902 can be, for example, a fiber laser, a gas laser, a semiconductor laser, a solid state laser, or a Raman laser.

The system 1900 further includes a plasmonic sensor 100, as disclosed with respect to FIG. 1. The laser 1902 is connected to the plasmonic sensor 100 via a channel 1916. The channel 1916 can be any type of channel that maintains polarization directions, such as a polarization-maintaining optical fiber 1916. One or more fiber connector/mating sleeves 1918 can be between the laser 1902 and the plasmonic sensor 100, as needed for making the connection therebetween, making sure that the fiber connector/mating sleeves 1918 do not change the polarization direction of an excitation signal.

In some implementations, a polarization-maintaining optical fiber coupler 1920 can be between the laser 1902 and the plasmonic sensor 100 for connecting a detector 1922, such as a spectrometer, to the plasmonic sensor 100. As before, one or more fiber connector/mating sleeves 1918 can be between the polarization-maintaining optical fiber coupler 1920 and the detector 1922 for making the connection.

Alternatively, rather than polarization-maintaining optical fiber coupler 1920, element 1920 within the system 1900 can instead be a polarization-maintaining optical fiber circulator 1920. A polarization-maintaining optical fiber circulator can minimize the back reflection into the laser 1902.

Other optional elements with the system 1900 can be a polarizer 1924 and a spectral filter 1926. The polarizer 1924 can be, for example, a film polarizer, a wire grid polarizer, a crystal polarizer, a polarizing beam splitter, a Wollaston prism, a Rochon prism, a calcite beam displacer, an yttrium orthovanadate beam displacer, a fiber polarization controller, or a combination of the aforementioned components. The spectral filter 1926 can be, for example, a notch filter, a longpass filter, a shortpass filter, or a bandpass filter. In some implementations, a fiber polarization controller can be within the system 1900, such as at element 1924, in place of a polarizer.

In the arrangement of the system 1900 shown in FIG. 19, an excitation signal, represented by arrow 1950, is generated by the laser 1902 and provided to the plasmonic sensor 100. The excitation signal 1950 has a specific polarization direction. In response to the excitation signal 1950 at the plasmonic sensor 100, a response signal, represented by the arrow 1952, is generated at the plasmonic material nanostructures (FIGS. 1, 104) of the plasmonic sensor 100. The response signal 1952 includes the SERS Stokes wave, with components of which being in the same polarization direction as the excitation signal 1950 and out of the polarization direction of the excitation signal 1950. Components of the response signal 1952 may further include reflection-generated and/or fiber-generated components, such as a reflected, fiber generated Stokes wave. However, based on the fibers 1916 within the system 1900 being polarization-maintaining optical fibers, the polarization directions of the signals 1950 and 1952 are maintained between the laser 1902, the plasmonic sensor 100, and the detector 1922. Thus, a specific (or more than one specific) polarization direction can be measured by the detector 1922, for analyzing a desired property of the response signal 1952, that is not affected by other components within the response signal 1952, such as the reflected, fiber-generated Stokes wave within the response signal 1952. Any polarization direction within the response signal 1952 that is outside the polarization direction of the excitation signal can be analyzed to discriminate the unwanted components within the response signal 1952. In preferred implementations, the polarization direction of the response signal 1952 that is analyzed is a polarization direction that is perpendicular to the polarization direction of the excitation signal 1950. Moreover, the system 1900 can include the advantages discussed above, such as the plasmonic material nanostructures being in a square lattice arrangement, and with the polarization direction of the excitation signal being at an angle θ of 45 degrees relative to the rows of plasmonic material nanostructures (FIG. 7).

According to some implementations, where a total Raman signal strength within the response signal 1952 is desired, rather than a Raman signal strength only with respect to a specific polarization direction, the system 1900 can be modified by replacing the polarization-maintaining optical fiber 1916 with regular (non-polarization-maintaining) optical fiber. Further, the plasmonic sensor 100 can be configured to have plasmonic material nanostructures arranged within the hexagonal lattice arrangement of FIGS. 6 and 8. In this arrangement, the polarization direction of the excitation signal 1952 is irrelevant for measuring the total Raman signal strength within the response signal 1952, as disclosed with respect to FIGS. 11 and 12. Thus, knowing the advantageous property of the hexagonal lattice arrangement of FIGS. 6 and 8 for the plasmonic material nanostructures within the plasmonic sensor 100 provides for an easier setup for the system 1900.

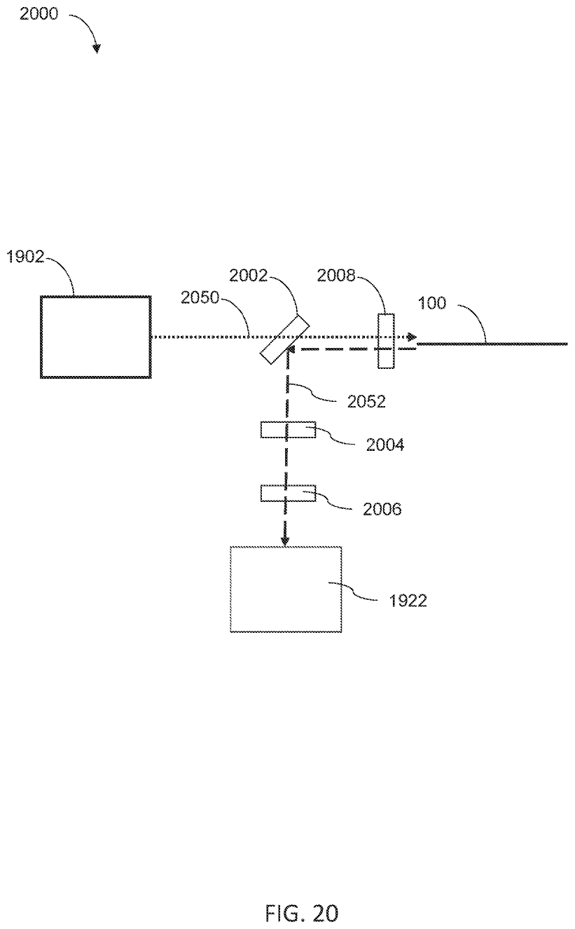

FIG. 20 shows another sensor system 2000, according to aspects of the present disclosure. In applications where precise alignment of system components is possible, the polarization-maintaining optical fiber 1916 (or regular optical fiber, as in the modified implementation of system 1900 disclosed above) can be removed. Instead, the excitation and response signals can propagate through air. Thus, the system 2000 includes the laser 1902 and detector 1922 of system 1900. The system 2000 further includes a beam splitter 2002. The laser 1902 provides an excitation signal, as represented by dotted line 2050, through the beam splitter 2002 to the plasmonic sensor 100 (FIG. 1). The excitation signal 2050 has a specific polarization direction. In response to the excitation signal 2050 at the plasmonic sensor 100, a response signal, represented by the dashed line 2052, is generated at the plasmonic material nanostructures (FIGS. 1, 104) of the plasmonic sensor 100. The response signal 2052 includes the SERS Stokes wave, with components of which being in the same polarization direction as the excitation signal 2050 and out of the polarization direction of the excitation signal 2052. Components of the response signal 2052 may further include reflection-generated components. The response signal 2052 the travels through air to the beam splitter 2002, where it (or a portion of it) is reflected toward the detector 1922. Thus, depending on the system layout, the detector 1922 can have a fiber-based, free-space-based, or chip-based configuration, or a combination of the aforementioned configurations. The system 2000 can optionally include a polarization optics module 2004 and/or a spectral filter 2006. Because the polarization directions within the response signal remain generally unchanged propagating through air, the system 2000 can still take advantage of the ability to measure the response signal for an optical property based only on a polarization direction different from the polarization of the excitation signal.

Optionally, the plasmonic sensor used in the system 2000 can include an optical fiber that is not polarization-maintaining, particularly in the situation where a total Roman signal strength is desired. Thus, instead of the plasmonic sensor 100 being in the system 2000, the system can include a conventional plasmonic sensor. In such an implementation, the system 2000 can include a fiber polarization controller 2008. This arrangement could be used based on the understanding of the total strength of the SERS response from a hexagonal lattice, such as that shown in FIG. 11 by line 1100. When implemented as FIG. 20, one possible scenario could be a benchtop system that offers precise alignment before the fiber of the plasmonic sensor, so that fiber-generated Stokes waves could be reduced since, overall, a shorter segment of fiber is used. The fiber element of the plasmonic sensor could still provide more flexible access to an analyte, since sometimes it may not be easy to place the specimen under an objective (as in the traditional setup of microscope-based SERS system). The optional fiber polarization controller 2008 could be used when additional analysis between both polarization components is desired.

Further, according to some implementations, the plasmonic sensor can be replaced with just the plasmonic material nanostructures or with just a plasmonic material nanostructure assembly because there is no requirement for the plasmonic sensor with an optical fiber when the excitation signal and the response signal propagate through air.

Although the present disclosure is directed predominantly to Raman signals, aspects of the present disclosure apply to other areas/types of optical measurement/phenomena. For example, aspects of the present disclosure can relate to surface-enhanced fluorescence. Certain fluorescence is fairly weak, such as being comparable in intensity to the signal strength of intrinsic fiber Raman signals. Polarization of fluorescence signals is typically isotropic, which can therefore couple into the direction of perpendicular polarization and, therefore, benefit from the above benefits of the present disclosure for similar reasons as discussed above for Raman signals. Thus, the plasmonic sensor of the present application can be used for surface-enhanced fluorescence measurements. In some specific aspects, the plasmonic sensor of the present application allows for fiber-based fluorescence detection in vivo via needle-like sensor applications.

Although the disclosed implementations have illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various implementations of the present disclosure have been described been above, it should be understood that they have been presented by way of example only, and not limitation. Numerous changes to the disclosed implementations can be made in accordance with the disclosure herein, without departing from the spirit or scope of the disclosure. Thus, the breadth and scope of the present disclosure should not be limited by any of the above-described implementations. Rather, the scope of the disclosure should be defined in accordance with the following claims and their equivalents.

1. A plasmonic sensor comprising:
a polarization-maintaining optical fiber having a proximal end and a distal end; and
plasmonic material nanostructures coupled to the distal end of the polarization-maintaining optical fiber.

2. The plasmonic sensor of claim 1, wherein the polarization-maintaining optical fiber has a length of at least about two meters, or wherein the polarization-maintaining optical fiber has an effectiveness for detecting surface enhanced Raman scattering at least about 12.5 times greater than a plasmonic sensor with a non-polarization-maintaining optical fiber, or both.

3. (canceled)

4. The plasmonic sensor of claim 1, further comprising a plurality of pillars, each pillar of the plurality of pillars supporting one nanostructure of the plasmonic material nanostructures.

5. The plasmonic sensor of claim 4, further comprising a substrate coupled to the plurality of pillars, wherein the substrate couples the plurality of pillars and the plasmonic material nanostructures to the distal end of the polarization-maintaining optical fiber.

6. The plasmonic sensor of claim 5, further comprising a support structure coupling the substrate to the distal end of the polarization-maintaining optical fiber to form a gap between the substrate and the distal end of the polarization-maintaining optical fiber.

7. The plasmonic sensor of claim 6, wherein the plasmonic material nanostructures are positioned within the gap between the substrate and the distal end of the polarization-maintaining optical fiber.

8. The plasmonic sensor of claim 1, wherein the plasmonic material nanostructures are arranged in a square lattice arrangement in a series of rows and a series of columns, or wherein the plasmonic material nanostructures are arranged in a hexagonal lattice arrangement, or wherein the plasmonic material nanostructures are arranged in a honeycomb lattice arrangement.

9. (canceled)

10. (canceled)

11. The plasmonic sensor of claim 1, further comprising one or more of a polarizer, a Faraday rotator, or a half-wave plate coupled between the plasmonic material nanostructures and the distal end of the polarization-maintaining optical fiber.

12. The plasmonic sensor of claim 11, wherein a gap exists between one or more of the distal end of the polarization-maintaining optical fiber and the one or more of the polarizer, the Faraday rotator, or the half-wave plate.

13. A system comprising:
a laser configured to provide an excitation signal having a first polarization direction;
a plasmonic sensor configured to generate a response signal responsive to the excitation signal, the response signal having the first polarization direction and a second polarization direction, different from the first polarization direction; and
a spectrometer configured to measure the response signal with respect to the second polarization direction distinct from the first polarization direction.

14. The system of claim 13, wherein the plasmonic sensor includes plasmonic material nanostructures arranged in:
a series of rows parallel to an x-axis, the x-axis being perpendicular to a propagation direction of the excitation signal within the plasmonic sensor,
a series of columns parallel to a y-axis, the y-axis being perpendicular to the propagation direction of the excitation signal within the plasmonic sensor, and
the first polarization direction of the excitation signal is within a plane oriented at a 45 degree angle relative to the x-axis and the y-axis.

15. The system of claim 14, wherein the second polarization direction is perpendicular to the first polarization direction.

16. The system of claim 13, wherein the plasmonic sensor includes a polarization-maintaining optical fiber.

17. The system of claim 16, further comprising a channel for connecting the laser to the plasmonic sensor and the plasmonic sensor to the spectrometer, wherein the channel is polarization-maintaining with anisotropic Raman gains.

18. The system of claim 17, wherein the polarization-maintaining channel is a polarization-maintaining fiber or polarization-maintaining photonic crystal fibers.

19. A method comprising:
providing an excitation signal to a plasmonic sensor, the excitation signal having a first polarization direction;
receiving a response signal from the plasmonic sensor, the response signal having the first polarization direction and a second polarization direction, different form the first polarization direction; and
measuring the response signal for an optical property based only on the second polarization direction.

20. The method of claim 19, wherein the second polarization direction is perpendicular to the first polarization direction.

21. The method of claim 19, wherein the plasmonic sensor includes plasmonic material nanostructures arranged within in:
a series of rows parallel to an x-axis, the x-axis being perpendicular to a propagation direction of the excitation signal,
a series of columns parallel to a y-axis, the y-axis being perpendicular to the propagation direction of the excitation signal, and
the first polarization of the excitation signal is arranged within a plane arranged at a 45 degree angle relative to the x-axis and the y-axis.

22. The method of claim 19, wherein the excitation signal is generated by a laser and provided to the plasmonic sensor from the laser by a polarization-maintaining optical fiber.

23. The method of claim 22, wherein the response signal is received from the plasmonic sensor at a spectrometer from a polarization-maintaining optical fiber.

24. The method of claim 19, further comprising:
measuring the response signal relative to the first polarization direction; and
determining a ratio of the response signal based on the measured first polarization direction and the measured second polarization direction.

25. The method of claim 19, wherein the optical property is based on Raman scattering or fluorescence.
